(19) United States
(12) Patent Application Publication
(10) Pub. No.: US 2017/0157826 A1
(43) Pub. Date: Jun. 8, 2017

(54) EXTRUDER FOR FUSED FILAMENT FABRICATION 3D PRINTER

(71) Applicant: RHOMBUS INTERNATIONAL TECHNOLOGIES LIMITED, Wanchai (HK)

(72) Inventor: Teruo HISHIKI, Tokyo (JP)

(21) Appl. No.: 15/372,379

(22) Filed: Dec. 7, 2016

Related U.S. Application Data
(63) Continuation of application No. PCT/IB2014/062163, filed on Jun. 12, 2014.

(51) Int. Cl. B29C 47/00; B29C 31/04; B29C 67/00; B29C 47/10; B29C 47/08

(52) U.S. Cl. CPC B29C 47/0014; B29C 47/1045; B29C 47/0866; B29C 67/0051; B29C 31/042

(57) ABSTRACT

Disclosed is an improved extruder head for a fused filament fabrication 3D printer. It would be beneficial with a thinner nozzle diameter and higher extrusion speed without slippage in the feeding mechanism. The proposed improved extruder head enables extrusion of thinner extruded material at a higher extrusion speed without any slippage in filament feeding mechanism, thereby allowing higher overall building speed of the 3D printer with high quality build. Higher feed-rate of the filament material is achieved by increased usable friction between pinch wheel and filament by increasing the grippable area of the filament. This is done by feeding the filament into the feeding mechanism at an angle different to the outlet angle and routing it around the pinch wheel, back supported by a plurality of support rollers, so that the filament is in frictional contact with the pinch wheel along a greater part of its circumference, thereby increasing the surface contact area between the pinch wheel and the filament. Owing to non-slippage of the filament feeder, nominal volume of extruded material is exactly the same as desired volume with high filament feeding rate. Due to compact feeding mechanism, total mass of extruder kept small enough to enable higher acceleration of the printing nozzle resulting higher printing speed. Owing to horizontal loading of the filament material, feed roll can be mounted just above the extruder for smooth filament supply and compact size of 3D printer.

### CROSS-REFERENCE TO RELATED APPLICATIONS

This application is a continuation of, and claims the benefit of PCT application PCT/IB2014/062163 filed Jun. 12, 2014, the contents of which are incorporated herein in their entirety.

### TECHNICAL FIELD

This invention relates to additive manufacturing systems, more particularly the extrusion head mechanism, or extruder, of a fused filament fabrication system.

### BACKGROUND ART

Fused Filament Fabrication is one of several known methods of 3D printing, where physical components can be manufactured directly from a 3D CAD (Computer Aided Design) model using an additive approach where material is deposited on a horizontal building surface layer by layer. Such layers are typically between 0.05 to 1.0 mm thick depending on the technology used and interpreted by translating ‘slices’ of the 3D CAD model into movement of an extrusion head for depositing material. In fused filament fabrication, the deposition technology is extrusion of polymer via an extruder, whereby a polymer filament is fed by a feeding unit into a heated nozzle and extruded in melted form into a string through a vertically oriented nozzle onto the horizontal building surface. The space between the printing nozzle and the building surface determines the layer thickness. By moving the printing nozzle relative to the building surface in the horizontal X and Y directions, whilst feeding building material at a controlled rate, a build layer can be completed, after which movement of the nozzle relative to the building surface one layer thickness in the positive Z direction allows printing of the next X-Y layer on top of the previously printed layer, and so on. Each new extruded bead of plastic fuses and bonds to the previously deposited material in X, Y and Z directions, making it possible to gradually build up physical objects based on the 3D CAD model. Several examples of the above type of 3D printers exists in the Art. Expired US patent no U.S. Pat. No. 5,121,329 Crump by Stratasys describes the basic form of manufacturing 3D models using extrusion of fluid materials through a printing nozzle, whereby the extruded fluid material solidifies onto to a building surface upon a drop of temperature. The above patent also teaches the use of a flexible filament building material housed on a supply spool, whereby the filament is drawn off the spool by two feed rollers and into a heated nozzle, causing the filament to melt and pass through the nozzle by the pressure created by the feed rollers. U.S. Pat. No. 5,764,521 Batchelder et. al. describes an alternative method of feeding building material using a feeding screw.

U.S. Pat. No. 5,968,561 Batchelder et. al. discloses improvements in the relative movement of the extrusion nozzle and the build platform. A common aim for 3D printers is to achieve the finest possible build resolution in the shortest possible time. In the case of a 3D printer based on the fused filament fabrication, the resolution of the build is proportional to the nozzle diameter and layer thickness. The speed of the build is proportional to the speed of extrusion of molten material from the nozzle which is determined by nozzle area and maximum volume of extruded molten material per second. Extrusion speed is determined by volume of extruded molten material divided by area of extruded molten string of material. In fact as the resolution of the build is doubled by smaller size of the nozzle, the speed of the build slows down by a factor 4. This resolution vs. build speed dilemma makes speed of extrusion a critical factor in improvement. A key subsystem in a fused filament fabrication 3D printer is the extruder. One type of extruder is the screw type, described in U.S. Pat. No. 5,764,521, where polymer material is fed into a heated feeder with a rotating feeding screw, which is able to extrude molten polymer at high pressure through to a nozzle. Although this type is typically capable of achieving high extrusion pressure, an important drawback is its weight which limits acceleration in the x-y plane and therefore overall printing speed. Another drawback is the large size of the screw mechanism, which makes it difficult to install into the 3D printer. A different type of extruder more commonly and preferably used consists of a ‘cold’ end having a filament feeder unit and a ‘hot’ end having a heated extrusion nozzle. The feeder pulls filament material off a supply roll and feeds it by pressure into the heated nozzle which consists of essentially a heated tube. The feeder unit design is critical, and several variants are known: The most commonly used method is to feed the filament in a straight line between a driven pinch wheel and a sprung pressure plate or idler wheel. The pinch wheel can be knurled, toothed, hobbed or otherwise treated to increase the friction and therefore traction force applicable on the filament. For example, a toothed pinch wheel where the tooth profile is concave to provide a line contact with the filament instead of a point contact would be preferable. Extrusion of thinner melted material at higher feed-rates is desired for high resolution and faster build speed. Both increased resolution and increased extrusion speed result in higher nozzle pressure relative to the grippable surface area of the filament and therefore the available friction between the filament and the feeding device. The gap between theoretical and actual extrusion speed increases due to slippage in the feeding device. Current technology of 3D printers is limited to extrusion of around 10 mm³/s which is equivalent to 80 mm/sec extrusion speed with a 0.4 mm diameter nozzle, using ABS material. Over this limit slippage becomes unacceptable, which can lead to poor quality and build interruptions. It would be beneficial if the technology could allow thinner nozzle diameter and higher extrusion speed by means of higher feed rate of the filament material without slippage in the feeding mechanism. It would also be beneficial is the construction was compact and lightweight, thereby enabling fast acceleration and a higher printing speed as a result.

### SUMMARY OF INVENTION

Disclosed is an improved extruder head for a fused filament fabrication 3D printer, which has a lightweight construction and enables extrusion of thinner extruded material at a higher extrusion speed without any slippage in filament feeding mechanism, thereby allowing higher overall building speed of the 3D printer. Higher feed-rate of the filament material is achieved by increased usable friction between pinch wheel and filament by increasing the grippable area of the filament. This is done by feeding the filament into the feeding mechanism at an angle different to the outlet angle and routing it around the pinch wheel, back-supported by a plurality of support rollers, so that the filament is in frictional contact with the pinch wheel along a greater part of its circumference, thereby increasing the surface contact area between the pinch wheel and the filament. Owing to non-slippage of the filament feeder, nominal volume of extruded material is exactly the same as desired volume with high filament feeding rate.

### BRIEF DESCRIPTION OF DRAWINGS

FIG. 1 shows a schematic layout of a 3D printer indicating the extruder head in relation to other key components.

FIG. 2 shows a 3D view of the extruder

FIG. 3 shows an exploded view of the extruder

FIG. 4 shows an exploded view of the extruder cold end

FIG. 5 shows a cross-sectional drawing of the extruder

FIG. 6 shows a detail of the extruder hot end.

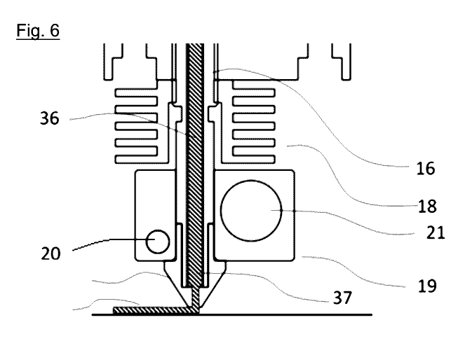

FIG. 7 shows an embodiment with 180 degree filament contact angle

### DESCRIPTION OF EMBODIMENTS

Table of Components

```
  1 Stepping motor
  2 Motor mount
  3 Extruder head
  4 Worm gear
  5 Extruder bracket
  6 Cooling fan
  7 Cold end heat sink
  8 8a Cover A, 8b Cover B
  9 9a-9f Support rollers
10 Pinch wheel
11 Pinch wheel shaft
12 Worm wheel
13 Worm wheel bearing
14 Filament inlet
15 Pinch wheel bearing
16 Hot end pipe
17 Thermal insulator
18 Hot end heat sink
19 Heater block
20 Temperature sensor
21 Heater
22 Nozzle
23 Filament
24 Filament outlet direction
25 Cold end
26 Hot end
27 3D printer
28 Filament roll
29 Building surface
30 Filament contact angle v
31 Support roller center distance d
32 Horizontal beam
33 Vertical beam
34 Filament roll support beam
35 Building surface linear guide
36 Partly molten polymer
37 Molten polymer
38 Extruded string of molten polymer
39 Filament guide groove
40 Filament guide tube
41 Filament inlet direction
```

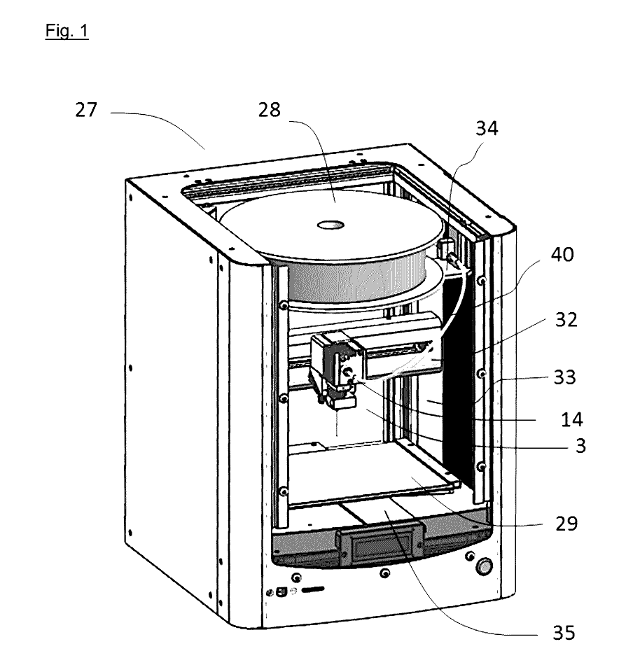

Referring to FIG. 1, according to the preferred embodiment, there is provided a 3D printer 27 having a horizontal build surface 29 movable in the horizontal Y direction guided by linear guide 35, and an extruder head 3 arranged on a horizontal beam 32 to be movable in the horizontal x and vertical z directions, and a filament roll 28 arranged on filament support beam 34 above the maximum movement of extruder head 3 on a rotation axle in order to freely dispense of filament indicated at 23 on demand into the extruder head 3 via filament inlet 14.

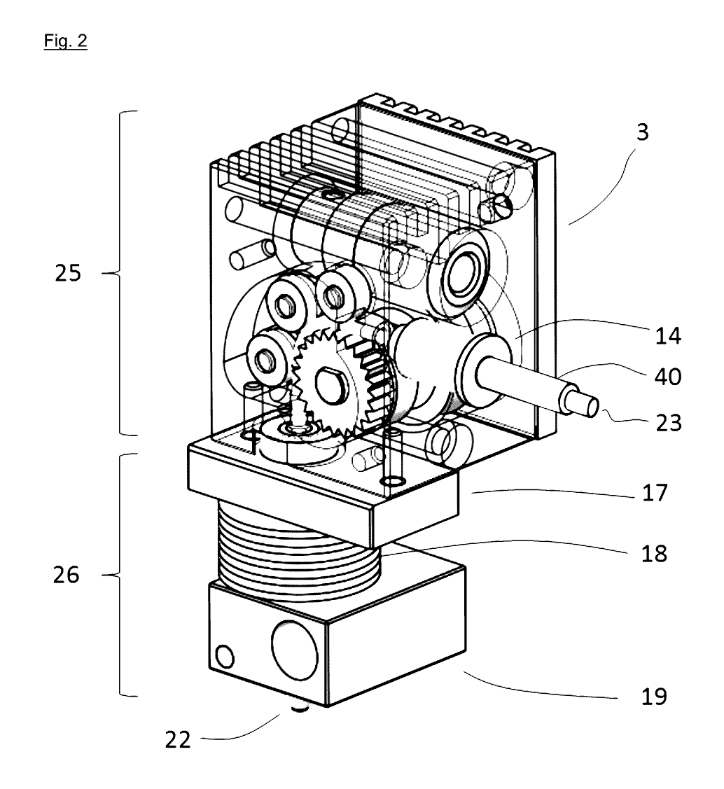

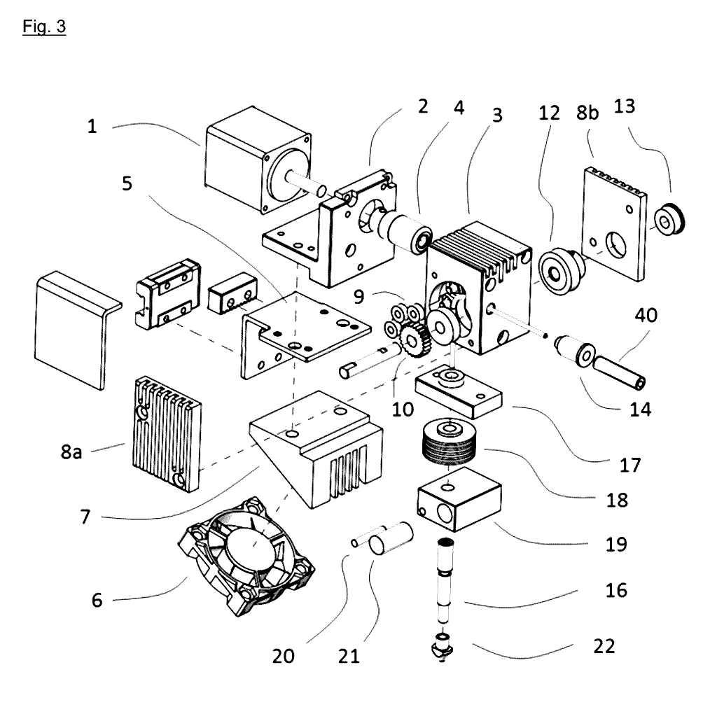

Moving to FIG. 2 and FIG. 3, the extruder head 3 generally comprises a cold end 25 and a hot end 26. The cold end comprises an extruder head 3 which houses a filament feed unit for pulling filament 23 off from filament roll 28 and pushing it into the hot end 26 via hot end pipe 16 into heater block 19 where it is liquefied by heat created by heater 21. Temperature is monitored by a temperature sensor 20 and fed back into a computer control unit which is not shown. Connected to the cold end 25 is a stepping motor 1, mounted on a motor mount 2 which is connected to the extruder head 3. Attached to motor mount 2 is a cool end heat sink 7 and cooling fan 6.

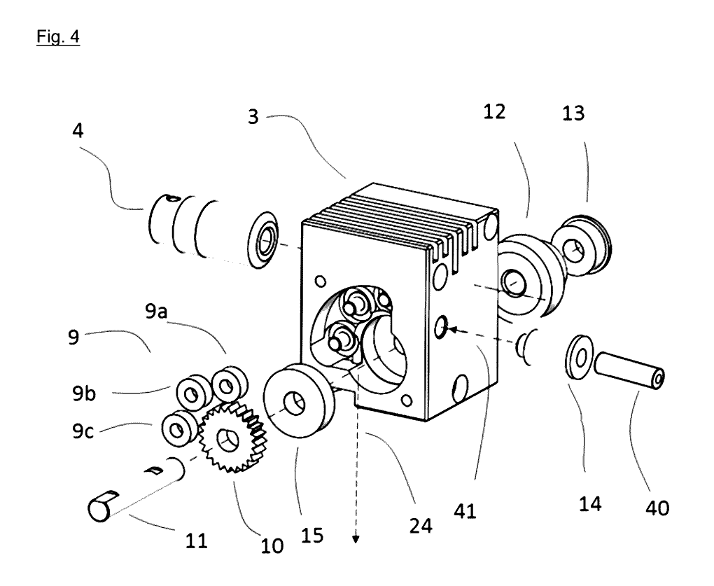

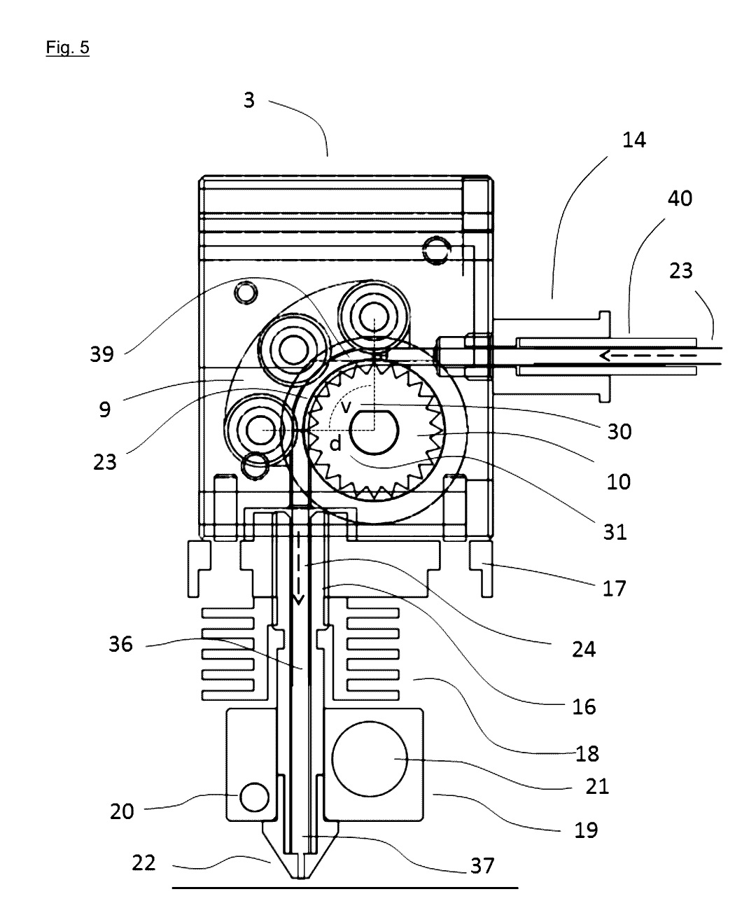

Now referring to FIGS. 4 and 5 for details of the extruder head 3 and the feeder unit. Inside the extruder head 3 is arranged a worm gear 4 driven by stepping motor 1. The worm gear 4 drives worm wheel 12 which is connected to pinch wheel 10 via pinch wheel shaft 11. The pinch wheel 10 is equipped with gripping means, preferably teeth, to maximize the pulling or pushing force on the filament 23. Arranged outside pinch wheel 10 on machined shafts are preferably three support rollers generally indicated at 9. The support rollers 9a, 9b and 9c in the preferred embodiment are preferably ball bearings of the same size and preferably distributed equally along an arc shape at equal support roller center distances d 31 from pinch wheel 10 and spaced from the pinch wheel 10 so that the gap between them forms a conduit suitable to receive and guide a filament 23 tight enough to give the pinch wheel 10 appropriate driving friction against filament 23. There may be an additional filament guide groove 39 to help the filament finding its way through the filament conduit. The center points of the support rollers 9a and 9c and the center point of pinch wheel 10 define a filament contact angle v 30. The filament contact angle v 30 is what defines the total grippable area by pinch wheel 10 on the filament 23. The force between pinch wheel 10 and filament 23 is defined by the gap between support rollers 9a, 9b, 9c and pinch wheel 10. The gap is smaller than the size of the filament 23, which forces the pinch wheel 10 to dig into the filament against the support force of support wheels 9a-9c. Therefore what defines the total available pulling or pushing force of pinch wheel 10 on filament 23 is defined by the filament contact angle v and the gap between pinch wheel 10 and support rollers 9a, 9b and 9c.

Now referring to FIG. 5 for details of the hot end 26. Filament 23 is pushed out from the feeding unit along a filament outlet direction indicated at 24, into the hot end pipe 16. Hot end pipe 16 leads the filament 23 from the cold end 25, where it is in a solid state, into the hot end 26 where it is liquefied by heat generated by heater 21 inside heater block 19 and finally extruded in liquid form through nozzle 22. To isolate the cold end 25 from the higher temperatures in the hot end 26, there is a hot end heat sink 18 to remove heat from hot end pipe 16, and a thermal insulator 17 to insulate the extruder head 3 from remaining heat in hot end pipe 16 and hot end heat sink 18.

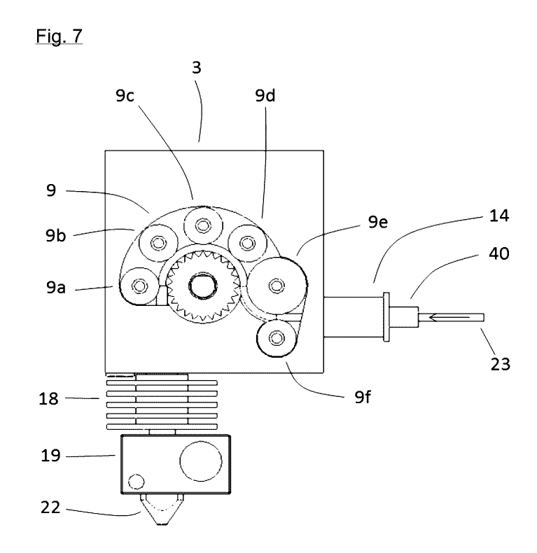

In another embodiment of the extruder head 3, it should be obvious for anybody skilled in the art that the number of support rollers generally indicated at 9 may vary depending on the size of them or the filament contact angle 30 desired. Therefore the distance between support rollers 9 may be shorter or longer depending on need. For example, instead of using three support rollers 9a, 9b and 9c, it is imaginable that four or five support rollers could be used to fill the desired filament contact angle v 30, if the individual rollers size was smaller and adequate to fill the space available under filament contact angle v 30. Equally, it is imaginable that only two support rollers may be used as long as the filament contact angle v 30 is longer than if using only one support roller. In case a greater filament contact angle 30 is required, for example 180 degrees, as many as six support rollers 9 may be needed, as indicated in FIG. 7. Support roller 9e may in this case, having six support rollers 9 giving a filament contact angle v 30 of 180 degrees, have to be larger to allow a sufficiently large bending radius of filament 23.

In yet another embodiment of the extruder head 3, it is imaginable that the support rollers generally indicated at 9 may be substituted by a general support means of low friction. For example, an arc-shaped guide designed to support the filament 23 over a filament contact angle v 30 but relying in low friction against the filament 23 whilst still providing sufficient pressure against pinch wheel 10. Such low friction could for example be achieved by a PTFE coat or highly polished surface on a steel guide.

In still another embodiment of the extruder head 3, it should be well known by someone skilled in the art that friction between pinch wheel 10 and filament 23 could be maximized in a number of ways, for example the surface of the pinch wheel 10 could be knurled, toothed, hobbed or otherwise surface treated to increase friction.

In a final embodiment of the extruder head 3, the support rollers 9 or support means may be spring loaded to provide a controlled pressure against pinch wheel 10.

1. An extruder head for a 3D printer of the fused filament fabrication type, having a filament feeder comprising of a filament inlet, a driven pinch wheel, and a plurality of support rollers arranged outside the pinch wheel to form an arc-shaped filament conduit between pinch wheel and support rollers, the support rollers being spaced from the pinch wheel to receive and guide a filament along the filament conduit in frictional contact with the pinch wheel, the center points of the two outermost support rollers and the pinch wheel defining a filament contact angle to increase the usable friction area between pinch wheel and filament material.

2. A feeder unit according to claim 1, where the filament contact angle is between 30 and 180 degrees.

3. The feeder unit according to claim 1, where the pinch wheel is knurled, hobbed or toothed to have friction in order to give traction of the filament

4. The feeder unit according to claim 1, where at least one of the support rollers is spring loaded towards the pinch wheel.

5. The feeder unit according to claim 1, where the distance between at least one support roller and the pinch wheel is adjustable.

6. The feeder unit according to claim 1, where guide means are provided along the arc-shaped filament conduit to guide the filament to initially find the correct path through the filament conduit.

7. An extruder head for a 3D printer of the fused filament fabrication type, having a filament feeder comprising of a filament inlet, a driven pinch wheel, and support means arranged outside the pinch wheel to form an arc-shaped filament conduit between pinch wheel and support means, the support means being spaced from the pinch wheel to receive and guide a filament along the filament conduit in frictional contact with the pinch wheel, the arc-length of the support means defining a filament contact angle to increase the usable friction area between pinch wheel and filament material.

8. A feeder unit according to claim 7, where the filament contact angle between 30 and 180 degrees.

9. The feeder unit according to claim 7, where the pinch wheel is knurled, hobbed or toothed to have friction in order to give traction of the filament.

10. The feeder unit according to claim 7, where the support means is spring loaded towards the pinch wheel.

11. The feeder unit according to claim 7, where the distance between the support means and the pinch wheel is adjustable.
